(19) United States
(12) Patent Application Publication
(10) Pub. No.: US 2006/0002023 A1
(43) Pub. Date: Jan. 5, 2006

(54) Magnetic head having a deposited second magnetic shield and fabrication method therefor

(76) Inventors: Quang Le, San Jose, CA (US); Edwin Hin Pong Lee, San Jose, CA (US); Jui-Lung Li, San Jose, CA (US); Nian-Xiang Sun, Sunnyvale, CA (US); Yi Zheng, San Ramon, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/883,327

(22) Filed: Jun. 30, 2004

(51) Int. Cl. G11B 5/147; G11B 5/127; G11B 5/33

(52) U.S. Cl. 360/126; 360/319

(57) ABSTRACT

The magnetic head includes a second magnetic shield that is fabricated in a deposition process. The present invention therefore does not require the deposition of the electrically conductive seed layer. In a preferred embodiment, the deposited second magnetic shield is comprised of cobalt zirconium tantalum (CZT). Because the CZT material is relatively soft, it is preferably deposited within an opening formed in a relatively hard RIEable material such as Ta₂O₅, SiO₂, Si₃N₃, and SiOₓN_{y}, such that a subsequent chemical mechanical polishing (CMP) step can be conducted down to the surface of the relatively hard layer.

### BACKGROUND OF THE INVENTION

1. Field of the Invention

The present invention relates generally to read heads for use in magnetic heads for hard disk drives, and more particularly to a read head which includes deposited second magnetic shield and a fabrication method therefor.

2. Description of the Prior Art

Magnetic heads for hard disk drives typically include a read head portion and a write head portion. In a commonly used read head, a magnetoresistive read sensor layered structure is located in a read region, while a magnetic hard bias element and an electrical lead element are located in each of two side regions. The sensor is fabricated between two magnetic shields that shield it from ambient magnetic fields, and the space between the two magnetic shields defines the sensor read gap in which it senses magnetic data bits on the rotating hard disk of the disk drive. The magnetic shields are typically fabricated in an electroplating process in which an electrically conductive seed layer is first deposited across the wafer surface upon an insulation layer, followed by a photolithographically patterned photoresist with openings created at desired magnetic shield locations. The magnetic shield is next electroplated upon the exposed seed layer within a magnetic shield opening in the photoresist. Following the electroplating of the magnetic shield, the photoresist and exposed seed layer are removed and an insulating fill layer is deposited across the wafer surface. A portion of the seed layer therefore remains beneath the magnetic shield that was electroplated upon it. A chemical mechanical polishing (CMP) step is next conducted to remove the insulating fill layer down to the surface of the electroplated magnetic shield, such that a flat surface is created for the subsequent fabrication of further magnetic head components.

In modern magnetic heads, the size of the magnetoresistive sensor is constantly being reduced to read ever smaller data bits on hard disks having greater areal data storage densities. The size of the read gap between the magnetic shields is likewise reduced in order to match the reduced data bit size. Improvements in the properties of the magnetic shields are also desirable to improve the performance of the heads.

Current magnetic shields are electroplated with NiFe80/20 material, but this material has a low Hk of around 2.5 Oe, which is a potential cause of write induced instability. Because of the low anisotropy field of the second magnetic shield, magnetic domain walls within the shield can be easily excited into unwanted movement by external fields as well as the stray fields from the write head poles. The domain wall motion in the second magnetic shield can cause noise in the read out signal from the read sensor, and result in write induced sensor instability when the magnetic domain walls in the second magnetic shield are located close to the sensor. The insulation layer between the sensor and the second magnetic shield must be thick enough to avoid this problem, and if the thickness of the insulation layer is reduced the noise can increase, such that the signal-to-noise ratio of the magnetic head will decrease. It is known that other soft magnetic films can offer higher anisotropy fields and can be excellent shield materials, like the CoZrTa alloy films that have been widely used as sensor shields in tape heads. However, many of these alloy films, like the CoZrTa films, cannot be electroplated in an aqueous environment, and have to be deposited by other methods like plasma vapor deposition (PVD).

For prior art electroplated thick shields, the seed layer is deposited and the shield is electroplated into a patterned photo-resist. But a deposited shield, which involves a full film deposition across the surface of the wafer, must be patterned by using etching methods, such as wet etching, ion milling, etc. For second magnetic shield patterning, there are two additional constraints that we have to be taken into consideration during the patterning process. The first constraint is that the very thin layer of insulation of the second gap, such as Al2O3, which may be less than 20 nm, should not be removed during the patterning. This automatically rules out ion milling, since severe over milling must be applied to ensure an acceptable vertical edge of the second magnetic shield. The second constraint is that the second magnetic shield patterning process should not necessitate an additional non-magnetic layer between the second gap and the second magnetic shield, which would add to the total shield to shield distance.

With regard to patterning a deposited second magnetic shield, wet etching might seem to be a good way to pattern it. However, the shield would have to be wet etched twice, since the ˜2 um shield would not allow for an accurate alignment right after deposition. The two wet etching steps would be: a first etch to open the alignment marks, and a second etch to define the shield island with accurate alignment. However, there would need to be a large tolerance because the wet etch process has a large variation and windage. Wet etching therefore is unsatisfactory, particularly when the shield dimensions are becoming smaller and smaller.

### SUMMARY OF THE INVENTION

The hard disk drive of the present invention includes the magnetic head of the present invention having an improved read head. The improved read head includes a second magnetic shield that is fabricated in a deposition process. This differs from prior art second magnetic shields that are electroplated, wherein an electrically conductive seed layer is first deposited, followed by the electroplating of the second magnetic shield within a suitably patterned opening in a photoresist layer. The present invention therefore does not require the deposition of the electrically conductive seed layer. In a preferred embodiment, the deposited second magnetic shield is comprised of cobalt zirconium tantalum (CZT). The CZT magnetic shield is preferably deposited within an opening formed in a relatively hard RIEable material such as Ta₂O₅, SiO₂, Si₃N₃, and SiOₓN_{y}. Because the CZT material is relatively soft, it is important that it is deposited within a relatively hard material such that a subsequent chemical mechanical polishing (CMP) step can be conducted down to the surface of the relatively hard layer. In an alternative embodiment, the relatively hard layer in which the CZT magnetic shield is deposited is comprised of a hard baked photoresist. The magnetic head of the present invention has an improved signal-to-noise ratio, and promotes the manufacture of hard disk drives having a greater areal data storage density.

It is an advantage of the magnetic head of the present invention that it has a read head sensor having improved magnetic shields.

It is another advantage of the magnetic head of the present invention that it has a read head sensor with a second magnetic shield that is comprised of a deposited material.

It is a further advantage of the magnetic head of the present invention that it includes a read head sensor having a second magnetic shield that is deposited within an opening formed within a RIEable material.

It is yet another advantage of the magnetic head of the present invention that it includes a read head sensor having a second magnetic shield that is comprised of deposited CZT.

It is an advantage of the hard disk drive of the present invention that it includes a magnetic head of the present invention which has a read head sensor having improved magnetic shields.

It is another advantage of the hard disk drive of the present invention that it includes a magnetic head of the present invention that it has a read head sensor with a second magnetic shield that is comprised of a deposited material.

It is a further advantage of the hard disk drive of the present invention that it includes a magnetic head of the present invention that it includes a read head sensor having a second magnetic shield that is deposited within an opening formed within a RIEable material.

It is yet another advantage of the hard disk drive of the present invention that it includes a magnetic head of the present invention that it includes a read head sensor having a second magnetic shield that is comprised of deposited CZT.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 is a top plan view generally depicting a hard disk drive of the present invention that includes a magnetic head of the present invention;

FIG. 2 is a side cross-sectional view depicting a typical prior art magnetic head;

FIG. 3 is an elevational view taken from the air bearing surface of the read head portion of the magnetic head depicted in FIG. 2;

FIGS. 4-8 are side cross-sectional views depicting steps in a fabrication process for a first embodiment of a magnetic head of the present invention;

FIG. 9 is a side elevational view of a first magnetic head embodiment of the present invention;

FIGS. 10-15 are side cross-sectional views depicting fabrication steps for a second magnetic head embodiment of the present invention;

FIG. 16 is a side elevational view of a second magnetic head embodiment of the present invention;

FIGS. 17-21 are side cross-sectional views depicting fabrication steps for a third magnetic head embodiment of the present invention; and

FIG. 22 is a side elevational view of a third magnetic head embodiment of the present invention.

### DETAILED DESCRIPTION OF THE PREFERRED EMBODIMENTS

FIG. 1 is a top plan view that depicts significant components of a hard disk drive which includes the magnetic head of the present invention. The hard disk drive 10 includes a magnetic media hard disk 12 that is rotatably mounted upon a motorized spindle 14. An actuator arm 16 is pivotally mounted within the hard disk drive 10 with a magnetic head 20 of the present invention disposed upon a distal end 22 of the actuator arm 16. A typical hard disk drive 10 may include a plurality of disks 12 that are rotatably mounted upon the spindle 14 and a plurality of actuator arms 16 having a magnetic head 20 mounted upon the distal end 22 of the actuator arms. As is well known to those skilled in the art, when the hard disk drive 10 is operated, the hard disk 12 rotates upon the spindle 14 and the magnetic head 20 acts as an air bearing slider that is adapted for flying above the surface of the rotating disk. The slider includes a substrate base upon which the various layers and structures that form the magnetic head are fabricated. Such heads are fabricated in large quantities upon a wafer substrate and subsequently sliced into discrete magnetic heads 20.

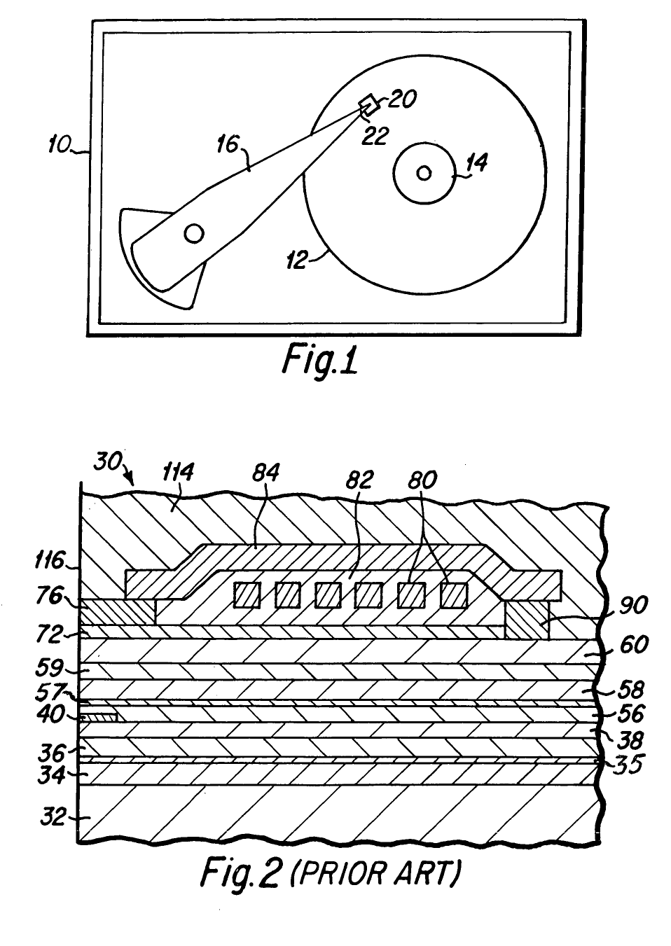

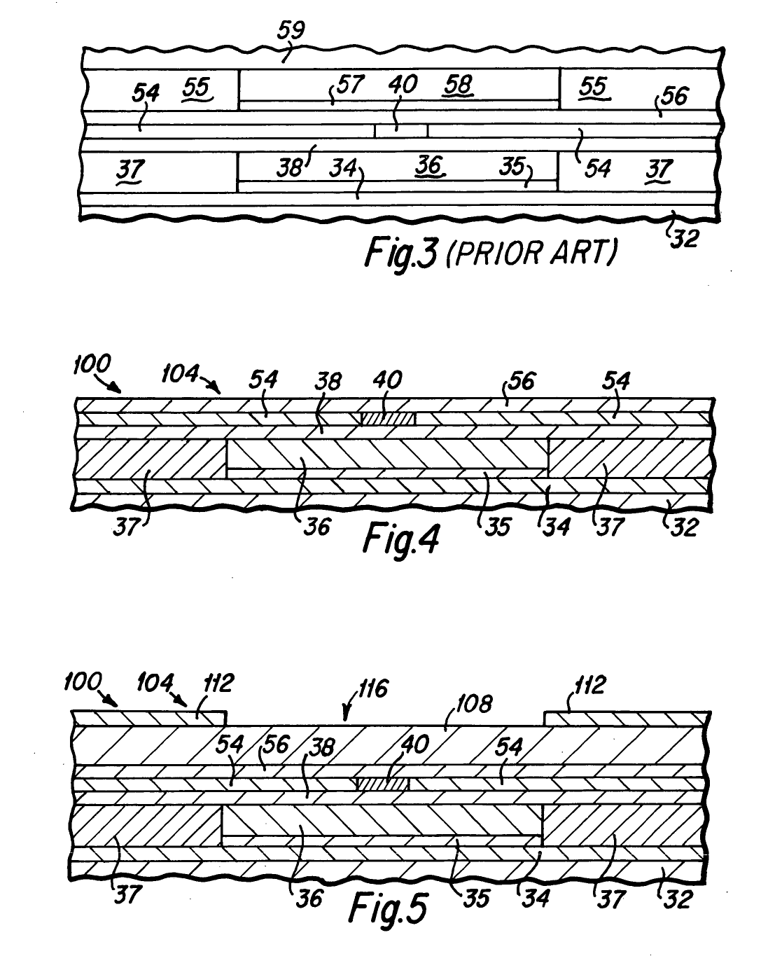

A typical prior art magnetic head structure is next described with the aid of FIGS. 2 and 3 to provide a basis for understanding the improvements of the present invention. As will be understood by those skilled in the art, FIG. 2 is a side cross-sectional view that depicts portions of a prior art magnetic head 30, termed a longitudinal magnetic head, and FIG. 3 is an elevational view of the read head portion of the magnetic head depicted in FIG. 2, taken from the air bearing surface of FIG. 2.

As depicted in FIGS. 2 and 3, a typical prior art magnetic head 30 includes a substrate base 32 with an insulation layer 34 formed thereon. An electrically conductive seed layer 35 is next deposited upon the insulation layer 34 and a first magnetic shield (S1) 36 is fabricated upon the seed layer 35. In fabricating the first magnetic shield 36, following the deposition of the seed layer 35, a photoresist is deposited across the surface of the wafer and patterned to create openings that expose the seed layer in the desired location of the first magnetic shield. Thereafter, an electroplating process is conducted in which the first magnetic shield is electroplated upon the seed layer in the openings formed through the photoresist. Following the electroplating process, the photoresist is removed and the portion of the seed layer that was disposed beneath the photoresist is also removed. The portion of the seed layer that is disposed beneath the first magnetic shield 36 remains. An insulative fill layer 37 is then deposited across the surface of the wafer, and a chemical mechanical polishing (CMP) step is then conducted to remove the excess insulator fill layer 37 down to the upper surface of the first magnetic shield, such that a flat surface is created for the subsequent fabrication of further read head components, as are next described.

A first insulation layer (G1) 38 of the read head is then deposited upon the wafer and the S1 magnetic shield 36. A magnetoresistive sensor 40, comprising a plurality of layers of specifically chosen materials, is then fabricated upon the G1 layer 38. Thereafter, electrical leads 54 are fabricated from the sensor towards magnetic head electrical contacts (not shown) to conduct the electrical sense current to the sensor for providing magnetic data bit signals from the sensor 40. A second insulation layer (G2) 56 is subsequently deposited across the top of the sensor 40 and electrical leads 54.

An electrically conductive seed layer 57 is next deposited upon the G2 insulation layer 56 and a second magnetic shield (S2) 58 is fabricated upon the seed layer 57. The second magnetic shield 58 is fabricated in a similar manner to the first magnetic shield 36. That is, in fabricating the second magnetic shield 58, following the deposition of the seed layer 57, a photoresist is deposited across the surface of the wafer and patterned to create openings that expose the seed layer 57 in the desired location of the second magnetic shield. Thereafter, an electroplating process is conducted in which the second magnetic shield 58 is electroplated upon the seed layer 57 in the openings formed through the photoresist. Following the electroplating process, the photoresist is removed and the portion of the seed layer 57 that was disposed beneath the photoresist is also removed. The portion of the seed layer that is disposed beneath the magnetic shield 58 remains in place. An insulative fill layer 55 is then deposited across the surface of the wafer, and a chemical mechanical polishing (CMP) step is then conducted to remove the excess insulator fill layer 55 down to the upper surface of the second magnetic shield 58, such that a flat surface is created for the subsequent fabrication of further magnetic head components, specifically, components of the write head portion of the magnetic head, as are next described.

Returning to FIG. 2, an electrical insulation layer 59 is then deposited upon the S2 shield 58, and a first magnetic pole (P1) 60 is fabricated upon the insulation layer 59. Following the fabrication of the P1 pole 60, a write gap layer typically composed of a non-magnetic material such as alumina 72 is deposited upon the P1 pole 60. This is followed by the fabrication of a P2 magnetic pole tip 76 and an induction coil structure, including coil turns 80, that is then fabricated within insulation 82 above the write gap layer 72. Thereafter, a yoke portion 84 of the second magnetic pole is fabricated in magnetic connection with the P2 pole tip 76, and through back gap element 90 to the P1 pole 60. Electrical leads (not shown) to the induction coil are subsequently fabricated and a further insulation layer 114 is deposited to encapsulate the magnetic head. The magnetic head 30 is subsequently fabricated such that an air bearing surface (ABS) 116 is created.

It is to be understood that there are many detailed features and fabrication steps of the magnetic head 30 that are well known to those skilled in the art, and which are not deemed necessary to describe herein in order to provide a full understanding of the present invention.

In the prior art magnetic heads 30, as depicted in FIGS. 2 and 3, the read gap, which is the distance between the first and second magnetic shield 36 and 58 respectively, is desirably small, such that ambient magnetic fields will be shielded from the sensor to reduce sensor noise. A problem with the read gap size becomes significant in advanced magnetic head designs where the size of the read head structures (such as the thickness of the G2 insulation layer 56) is decreased in order to read smaller data bits that are formed on magnetic disks having increased areal data storage density. Particularly, the closeness of the second magnetic shield 58 to the sensitive sensor layers 40 allows for unwanted domain movement within the second magnetic shield to create noise within the sensor signal. A new second magnetic shield material with higher anisotropy and higher Hk is desired. A deposited material, such as CZT is acceptable, however, CZT is so mechanically soft that its use presents a problem. The present invention provides a solution to this problem.

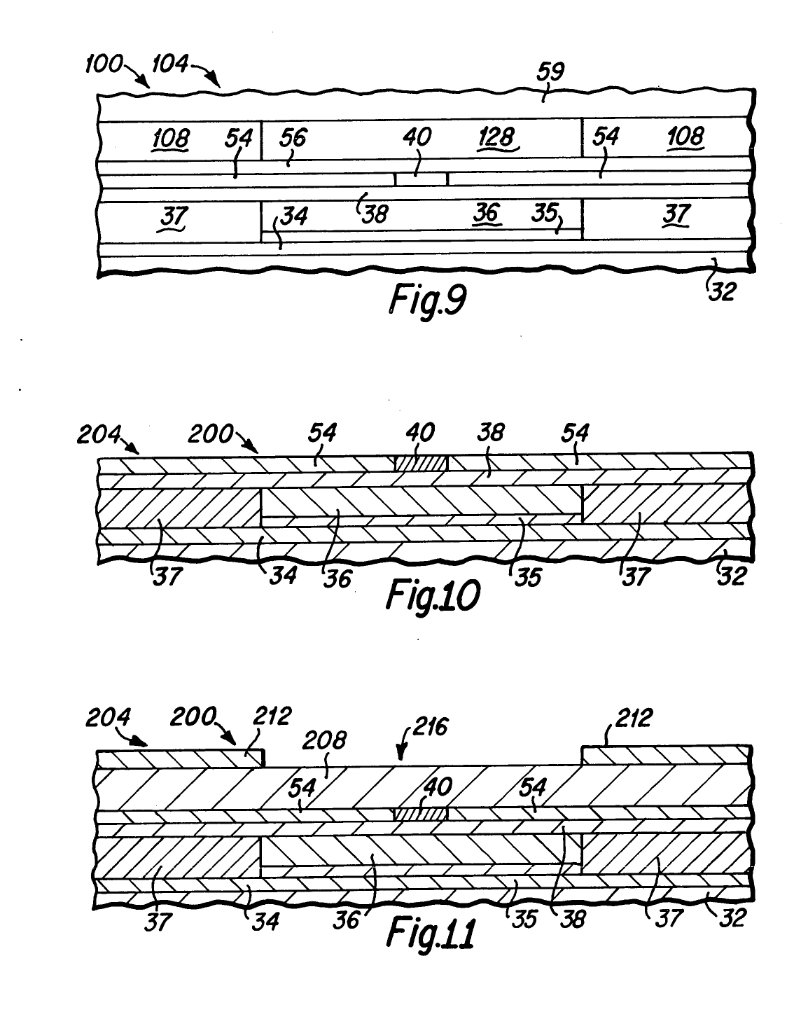

FIGS. 4-8 are side cross-sectional views depicting steps in a read head fabrication process for a first embodiment 104 of a magnetic head of the present invention, and FIG. 9 is a side elevational view of a completed read head portion 100 of the first magnetic head embodiment 104 of the present invention. FIGS. 4-8 are presented as cross-sectional views in that they depict fabrication steps that are conducted on a wafer substrate, where FIGS. 4-8 are taken from the location of the future air bearing surface (ABS) of the magnetic head; FIG. 9 is taken from the ABS of the completed magnetic head 104. As will be understood from the following description, the significant differences between the various magnetic heads of the present invention and the prior art magnetic head 30 depicted in FIGS. 2 and 3 relates to the structure of the second magnetic shield 58, and other features and structures of the magnetic heads of the present invention may be similar to those of the prior art magnetic head 30, and similar structures are numbered identically for ease of understanding.

With reference to FIG. 4, the initial fabrication steps of a read head portion 100 of a first embodiment of a magnetic head 104 of the present invention are depicted. As depicted in FIG. 4, the read head portion 100 includes a substrate base 32 with an insulation layer 34 formed thereon. An electrically conductive seed layer 35 is next deposited upon the insulation layer 34 and a first magnetic shield (S1) 36 is fabricated upon the seed layer 35.

A first insulation layer (G1) 38 of the read head 100 is then deposited upon the wafer and the S1 magnetic shield 36. A magnetoresistive sensor 40, comprising a plurality of layers of specifically chosen materials, is then fabricated upon the G1 layer 38. Thereafter, electrical leads 54 are fabricated from the sensor towards magnetic head electrical contacts (not shown) to conduct the electrical sense current to the sensor for providing signals from the sensor 40. A second insulation layer (G2) 56 is subsequently deposited across the top of the sensor 40 and electrical leads 54.

As is next depicted in FIG. 5, a nonmagnetic, insulative layer 108 is then deposited across the wafer surface on top of the G2 insulation layer 56. The insulative layer 108 is comprised of a material that is etchable in a reactive ion etch (RIE) process, termed a RIEable material herein, and such materials include Ta₂O₅, SiO₂, Si₃N₃, and SiOₓN_{y} as examples. The silicon based nonmagnetic, insulative materials are etchable in a fluorine ion based RIE process

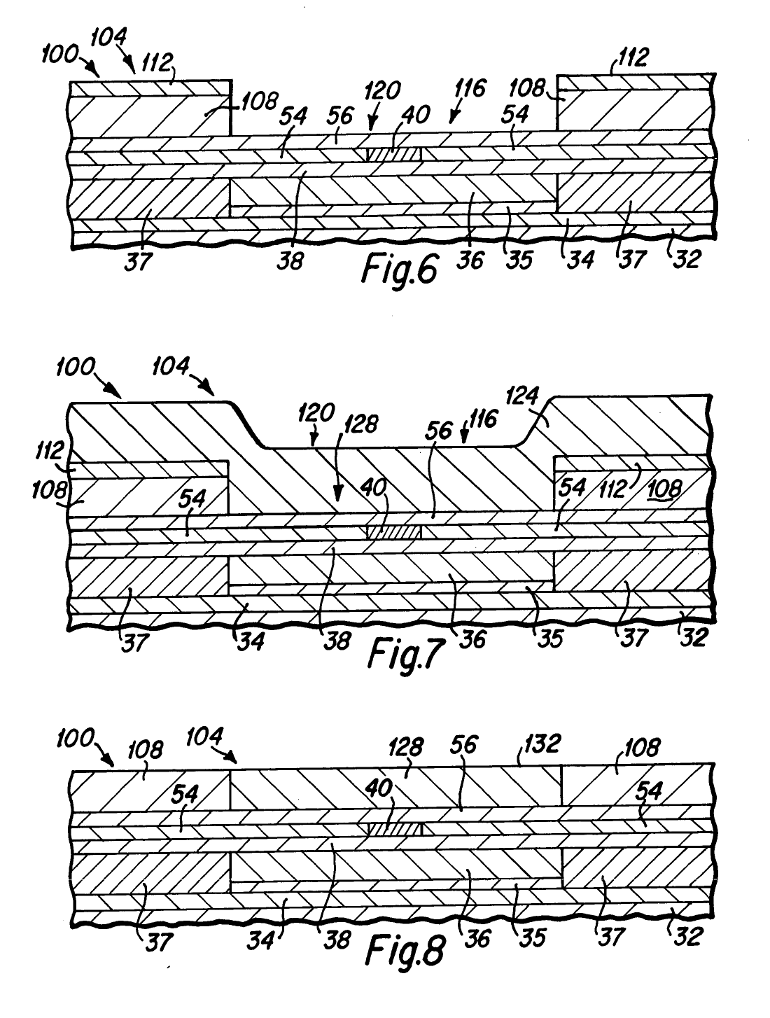

Following the deposition of the layer 108, a photoresist layer 112 is deposited across the surface of the wafer and photolithographically patterned to create openings 116 of the desired shape and at the location at which the second magnetic shield is to be created. Thereafter, as depicted in FIG. 6, an RIE process is conducted in which the photoresist 112 acts as an etching mask, and in which the layer 108 is etched through the openings 116 in the photoresist layer 112 down to the G2 insulation layer 56 to create a magnetic shield trench 120 within the layer 108. The G2 insulation layer 56 acts as an etch stop layer, and therefore, where the layer 108 is comprised of a silicon based material, the G2 insulation layer 56 can be comprised of a material such as alumina or any other materials having an RIE chemistry that has a low selectivity as compared to the material comprising the RIEable layer 108.

With reference to FIG. 7, the material 124 that comprises the second magnetic shield 128 is next deposited across the surface of the wafer in sufficient thickness to fill the etched magnetic shield openings 120 and 116 above the thickness of the photoresist 112. The deposited magnetic shield material 124 must have appropriate magnetic properties to function as a magnetic shield for the sensor 40, and a suitable material for the deposited second magnetic shield is cobalt zirconium tantalum, known as CZT.

As depicted in FIG. 8, a chemical mechanical polishing (CMP) is next conducted to remove the excess CZT material 124 and photoresist mask 112, down to the surface of the insulative layer 108. CZT is known to be a mechanically soft material, and the CMP process therefore relies on the hardness of the insulative material 108 as a polishing stop layer. The insulative layer materials identified hereabove provide sufficient hardness to protect the softer CZT during the CMP process. However, where the hardness of the RIEable material layer 108 is deemed insufficient, a thin chemical mechanical polish (CMP) stop layer (not shown) such as diamond like carbon (DLC) can be deposited upon the RIEable layer 108 prior to the deposition of the photoresist layer 112.

As will be understood by those skilled in the art, a desirable CMP slurry is a silicon based slurry with hydrogen peroxide as an oxidizer; a preferred slurry utilizes MH817 plus H₂O₂. A recommended CMP pad is an IC 1000 KXY pad, and the CMP conditions include a 4 psi pressure at a 45 rpm polishing table rotation speed.

Where it is desirable that the RIEable insulation layer 108 be replaced with an insulation material such as alumina, following the CMP step, a second RIE step can be conducted to remove the remaining RIEable insulation material 108. Thereafter, a layer of alumina can be deposited, and a second CMP step is then conducted to reexpose the surface of the CZT second magnetic shield 128.

Following the CMP step the fabrication of the second magnetic shield 128 is completed. The CMP process results in a flat surface 132 upon which the further magnetic head components, as described hereabove, can be fabricated, including the fabrication of the write head components the dicing of the wafer substrate and the subsequent creation of the air bearing surface of the magnetic head, all as described hereabove. FIG. 9 depicts the read head portion 100 of the first magnetic head embodiment 104 of the present invention as taken from the ABS surface. As depicted therein, the read head portion 100 includes the substrate base 32, insulation layer 34, seed layer 35, first magnetic shield 36, G1 insulation layer 38, sensor 40, electrical leads 54, G2 insulation layer 56, second magnetic shield 128, RIEable insulative layer 108, and the electrical insulation layer 59 that is deposited upon the second magnetic shield 128 and RIEable insulative layer surface 132. Thereafter, the write head portion (not shown in FIG. 9) of the first magnetic head embodiment 104 is fabricated. This write head portion may be identical to the write head portion of the prior art magnetic head 30 as described hereabove. However, the magnetic head of the present invention is not to be so limited, and may include virtually any write head design that is compatible with the read head portion 100 described herein.

A significant feature of the first magnetic head embodiment 104 of the present invention is that the second magnetic shield 128 is comprised of a material having a higher anisotropy and higher Hk than the prior art electroplated NiFe shield. The deposited CZT material of the second magnetic shield of the present invention therefore creates less signal noise, and the head has a higher signal-to-noise ratio. Additionally, it is advantageous in that a thinner G2 insulation layer 56 can be possibly be used. This would allow the magnetic shields 36 and 128 to be advantageously fabricated closer together, such that the read gap of the magnetic head 104 is reduced as compared to the prior art. The magnetic head 104 may be thus utilized with hard disk drives including hard disks having a greater data areal storage density, which necessitates the creation of smaller data bits and requires the utilization of magnetic heads having the smaller read gap of the magnetic head 104 of the present invention.

A second embodiment 204 of a magnetic head of the present invention is depicted in FIGS. 10-16, wherein FIGS. 10-15 are side cross-sectional views depicting steps in a read head fabrication process for the second magnetic head embodiment 204, and FIG. 16 is a side elevational view of a completed read head portion 200 of the second magnetic head embodiment 204. FIGS. 10-15 are presented as cross-sectional views in that they depict fabrication steps that are conducted on a wafer substrate, where FIGS. 10-15 are taken from the location of the future air bearing surface (ABS) of the magnetic head; FIG. 16 is taken from the ABS of the completed magnetic head 204. As will be understood from the following description, the significant differences between the various magnetic heads of the present invention and the prior art magnetic head 30 depicted in FIGS. 2 and 3 relates to the structure of the second magnetic shield, and other features and structures of the magnetic heads of the present invention may be similar to those of the prior art magnetic head 30, and similar structures are numbered identically for ease of understanding.

With reference to FIG. 10, the initial fabrication steps of a read head portion 200 of a second embodiment of a magnetic head 204 of the present invention are depicted. As depicted in FIG. 10, the read head portion 200 includes a substrate base 32 with an insulation layer 34 formed thereon. An electrically conductive seed layer 35 is next deposited upon the insulation layer 34 and a first magnetic shield (S1) 36 is fabricated upon the seed layer 35.

A first insulation layer (G1) 38 of the read head 200 is then deposited upon the wafer and the S1 magnetic shield 36. A magnetoresistive sensor 40, comprising a plurality of layers of specifically chosen materials, is then fabricated upon the G1 layer 38. Thereafter, electrical leads 54 are fabricated from the sensor towards magnetic head electrical contacts (not shown) to conduct the electrical sense current to the sensor for providing magnetic data bit signals from the sensor 40.

As is next depicted in FIG. 11, a nonmagnetic, insulative layer 208 is next deposited across the wafer surface on top of the electrical leads 54 and upper surface of the sensor 40. The insulative layer 208 is comprised of a material that is etchable in a reactive ion etch (RIE) process, termed a RIEable material herein, and such materials include Ta₂O₅, SiO₂, Si₃N₃, SiOₓN_{y}, as examples. The silicon based nonmagnetic insulative materials are etchable in a fluorine ion based RIE process. Following the deposition of the nonmagnetic, insulative layer 208, a photoresist layer 212 is deposited across the surface of the wafer and photolithographically patterned to create openings 216 of the desired shape and at the location at which the magnetic shield is to be created. Thereafter, as depicted in FIG. 12, an RIE process is conducted in which the photoresist 212 acts as an etching mask, and in which the nonmagnetic, insulative layer 208 is etched through the openings 216 in the photoresist layer 212 down to the surface of the electrical leads 54 and the upper surface of the sensor 40 to create a magnetic shield trench 220 within the insulative layer 208.

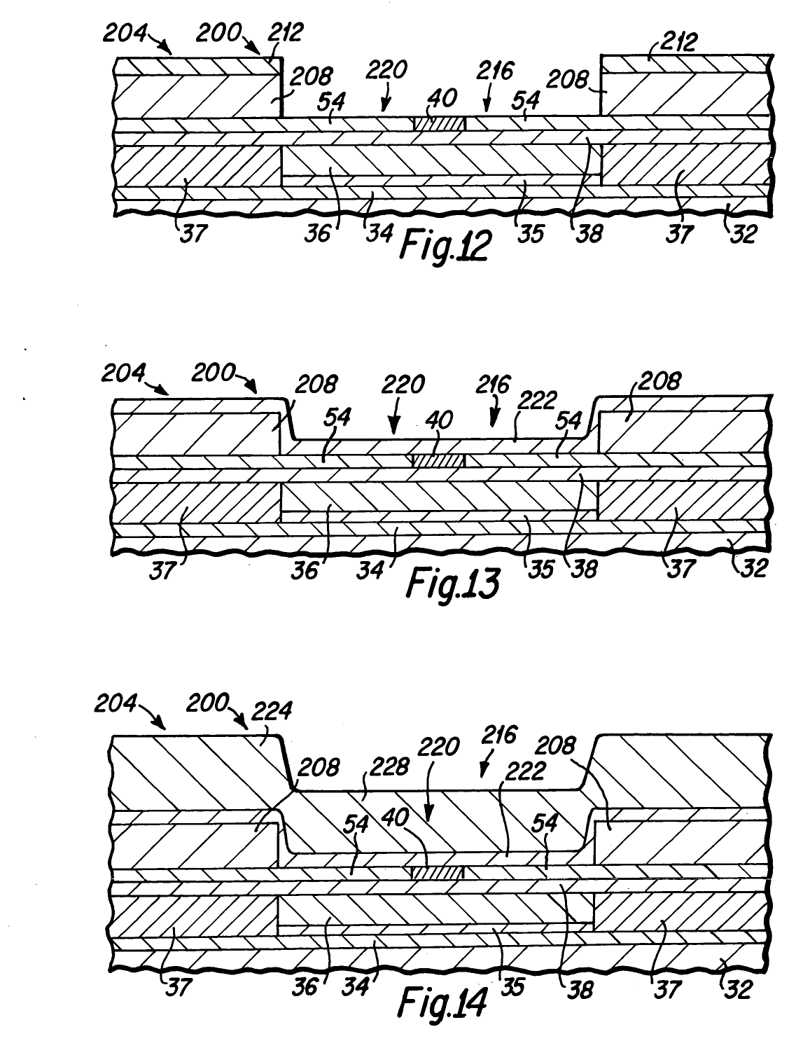

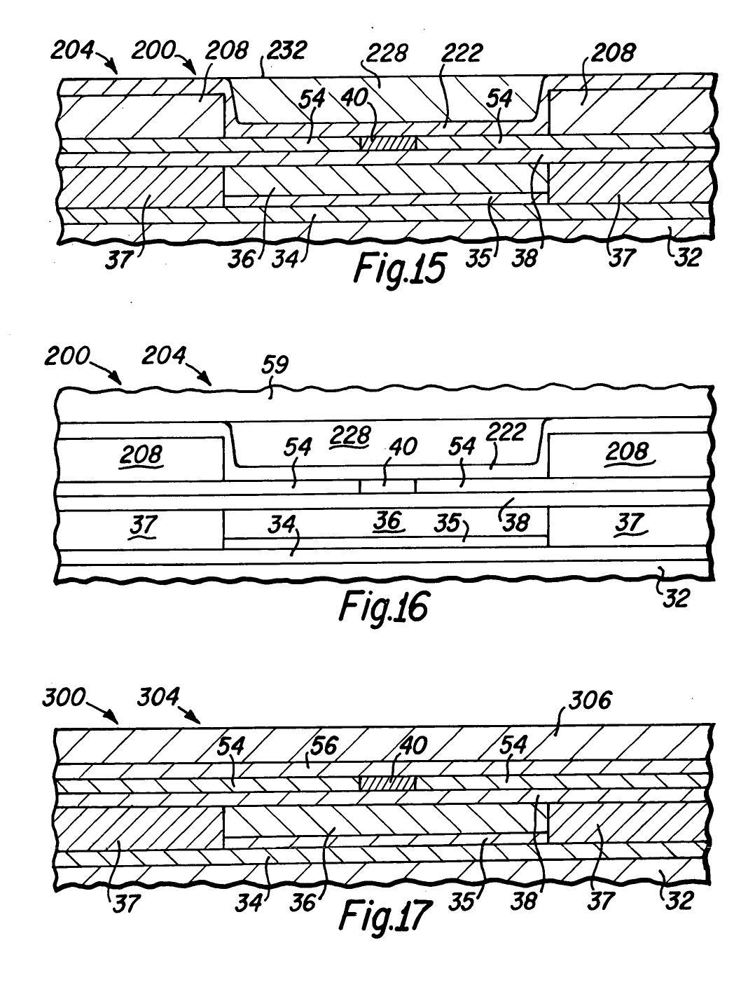

As is next seen in FIG. 13, the photoresist layer 212 is removed, such as by a wet chemical stripping process, and an insulation layer 222, which functions as the G2 insulation layer, is next deposited across the surface of the wafer. The G2 insulation layer 222 is therefore deposited into the magnetic shield trench 220 and on top of the insulative layer 208. With reference to FIG. 14, the material 224 that comprises the second magnetic shield 228 is next deposited across the surface of the wafer upon the G2 insulation layer 222 in sufficient thickness to fill the etched magnetic shield openings 220 and 216 above the thickness of the G2 insulation layer 222. The deposited magnetic shield material 224 must have appropriate magnetic properties to function as a magnetic shield for the sensor 40, and a suitable material for the deposited second magnetic shield is cobalt zirconium tantalum, known as CZT.

As depicted in FIG. 15, a chemical mechanical polishing (CMP) is next conducted to remove the excess CZT material 124, down to the surface of the G2 insulation layer 222. CZT is known to be a mechanically soft material, and the CMP process therefore relies on the hardness of the G2 insulation layer 222 as a polishing stop layer. As will be understood by those skilled in the art, a desirable CMP slurry is a silicon based slurry with hydrogen peroxide as an oxidizer; a preferred slurry utilizes MH817 plus H₂O₂. A recommended CMP pad is an IC 1000 KXY pad, and the CMP conditions include a 4 psi pressure at a 45 rpm polishing table rotation speed.

Following the CMP step the fabrication of the second magnetic shield 228 is completed. The CMP process results in a flat surface 232 upon which the further magnetic head components, as described hereabove, can be fabricated, including the fabrication of the write head components the dicing of the wafer substrate and the subsequent creation of the air bearing surface of the magnetic head, all as described hereabove. FIG. 16 depicts the read head portion 200 of a completed second magnetic head embodiment 204 of the present invention as taken from the ABS surface. As depicted therein, the read head portion 200 includes the substrate base 32, insulation layer 34, seed layer 35, first magnetic shield 36, G1 insulation layer 38, sensor 40, electrical leads 54, RIEable insulative layer 208, G2 insulation layer 222, second magnetic shield 228 and the electrical insulation layer 59 that is deposited upon the second magnetic shield and outer portion of the G2 insulation layer surface 222. Thereafter, the write head portion (not shown in FIG. 16) of the second magnetic head embodiment 204 is fabricated. This write head portion may be identical to the write head portion of the prior art magnetic head 30 as described hereabove. However, the magnetic head of the present invention is not to be so limited, and may include virtually any write head design that is compatible with the read head portion 200 described herein.

A significant feature of the second magnetic head embodiment 204 of the present invention is that the writer induced noise in the sensor signal is reduced due to the improved material that comprises the second magnetic shield. Additionally, the read gap between the magnetic shields 36 and 228 may be reduced as compared to the prior art magnetic head 30, in that the improved second magnetic shield material may allow for a thinner G2 insulation layer to be used, as has been discussed above. This would allow the magnetic shields 36 and 228 to be advantageously fabricated closer together, such that the read gap of the magnetic head 204 is reduced as compared to the prior art. The magnetic head 204 may be thus utilized with hard disk drives including hard disks having a greater data areal storage density, which necessitates the creation of smaller data bits and requires the utilization of magnetic heads having a smaller read gap.

A third embodiment 304 of a magnetic head of the present invention is depicted in FIGS. 17-22, in which FIGS. 17-21 are side cross-sectional views depicting steps in a read head fabrication process for the third embodiment 304 of a magnetic head of the present invention, and FIG. 22 is a side elevational view of a completed read head portion 300 of the third magnetic head embodiment 304 of the present invention. FIGS. 17-21 are presented as cross-sectional views in that they depict fabrication steps that are conducted on a wafer substrate, where FIGS. 17-21 are taken from the location of the future air bearing surface (ABS) of the magnetic head; FIG. 22 is taken from the ABS of the completed magnetic head 304. As will be understood from the following description, the significant differences between the various magnetic heads of the present invention and the prior art magnetic head 30 depicted in FIGS. 2 and 3 relates to the structure of the second magnetic shield, and other features and structures of the magnetic heads of the present invention may be similar to those of the prior art magnetic head 30, and similar structures are numbered identically for ease of understanding.

With reference to FIG. 17, the initial fabrication steps of a read head portion 300 of a first embodiment of a magnetic head 304 of the present invention are depicted. As depicted in FIG. 4, the read head portion 300 includes a substrate base 32 with an insulation layer 34 formed thereon. An electrically conductive seed layer 35 is next deposited upon the insulation layer 34 and a first magnetic shield (S1) 36 is fabricated upon the seed layer 35.

A first insulation layer (G1) 38 of the read head 300 is then deposited upon the wafer and the S1 magnetic shield 36. A magnetoresistive sensor 40, comprising a plurality of layers of specifically chosen materials, is then fabricated upon the G1 layer 38. Thereafter, electrical leads 54 are fabricated from the sensor towards magnetic head electrical contacts (not shown) to conduct the electrical sense current to the sensor for providing magnetic data bit signals from the sensor 40. A second insulation layer (G2) 56 is subsequently deposited across the top of the sensor 40 and electrical leads 54.

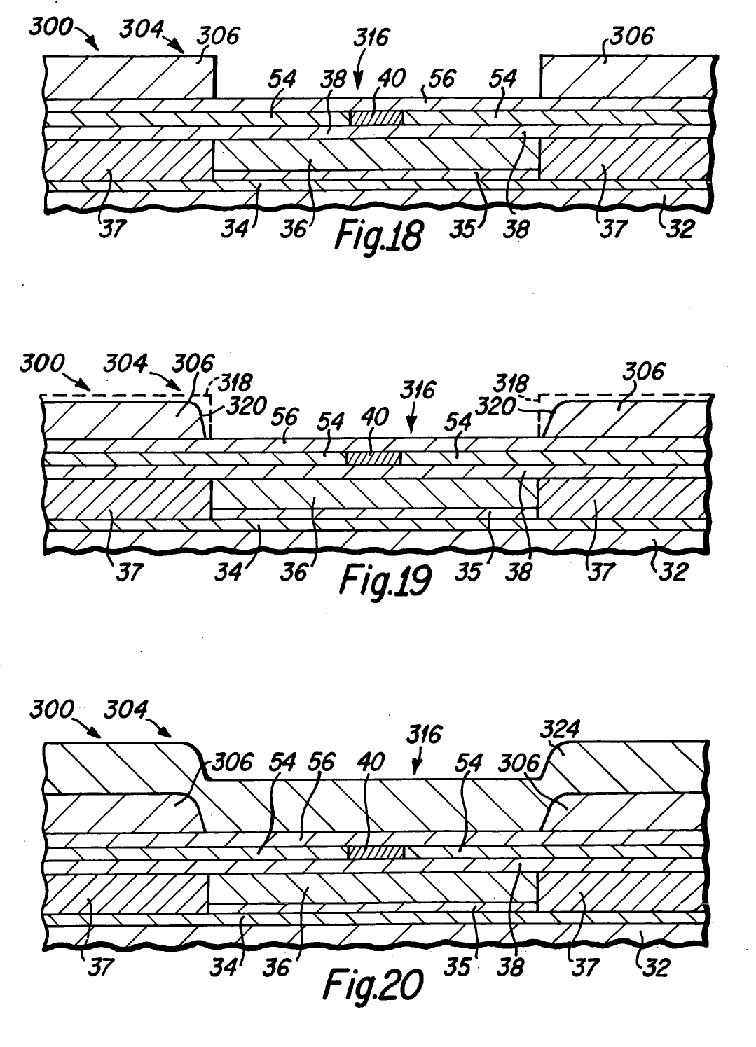

As is next depicted in FIG. 18, a photoresist layer 306 is next deposited across the surface of the wafer and photolithographically patterned to create openings 316 within which the second magnetic shield is to be created. Thereafter, as depicted in FIG. 19, the wafer is subjected to a baking process in order to hard bake the photoresist. This is necessary to bake off moisture and volatile compounds within the resist layer that will otherwise interfere with the CZT material deposition process that follows. The hard baking of the photoresist in this step can create some dimensional problems, in that the edges of the photoresist shrink and become distorted during a hard bake process, such as from the dashed original unbaked profile 318 to the somewhat shrunken hard baked profile 320. Due to the dimensional constraints of a magnetic head, the precise location of the second magnetic shield may be a significant parameter, and the first and second magnetic head embodiments described hereabove, which utilize a RIEable insulator layer, are somewhat favored over this third embodiment, in that the location of the second magnetic shield can be established with greater precision where an RIE process is used. However, where the possible amount of change in the magnetic shield location due to the hard baking of the photoresist is not a significant parameter, this third head embodiment is adaptable.

With reference to FIG. 20, the material 324 that comprises the second magnetic shield 328 is next deposited across the surface of the wafer in sufficient thickness to fill the magnetic shield opening 316 above the thickness of the hard baked photoresist 306. The deposited magnetic shield material 324 must have appropriate magnetic properties to function as a magnetic shield for the sensor 40, and a suitable material for the deposited second magnetic shield is cobalt zirconium tantalum, known as CZT.

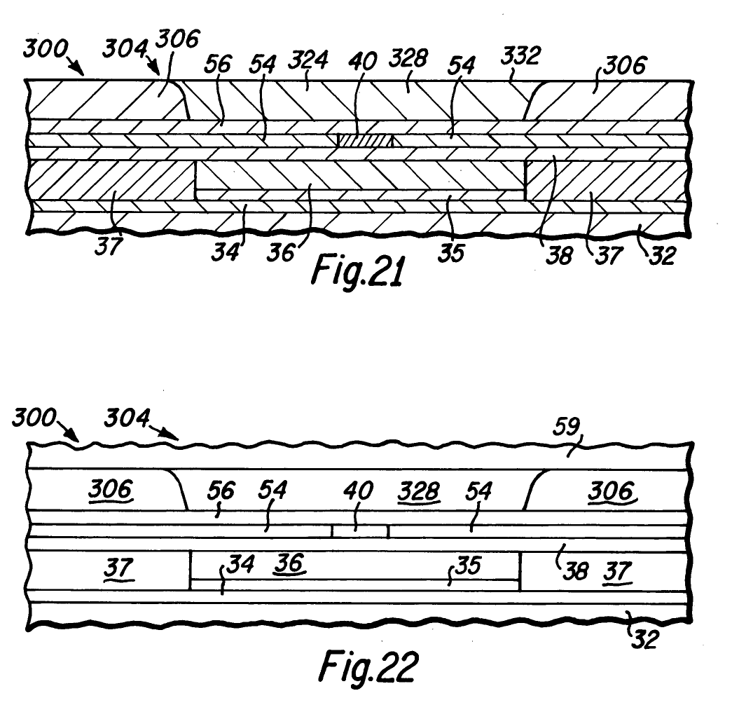

As depicted in FIG. 21, a chemical mechanical polishing (CMP) is next conducted to remove the excess CZT material 324 down to the surface of the hard baked photoresist layer 306. CZT is known to be a mechanically soft material, and the CMP process therefore relies on the hardness of the hard baked resist 306 as a polishing stop layer. As will be understood by those skilled in the art, a desirable CMP slurry is a silicon based slurry with hydrogen peroxide as an oxidizer; a preferred slurry utilizes MH817 plus H₂O₂. A recommended CMP pad is an IC 1000 KXY pad, and the CMP conditions include a 4 psi pressure at a 45 rpm polishing table rotation speed Following the CMP process the fabrication of the second magnetic shield 328 is completed. The CMP process results in a flat surface 332 upon which the further magnetic head components, as described hereabove, can be fabricated, including the fabrication of the write head components the dicing of the wafer substrate and the subsequent creation of the air bearing surface of the magnetic head, all as described hereabove. FIG. 22 depicts the read head portion 300 of the third magnetic head embodiment 304 of the present invention as taken from the ABS surface. As depicted therein, the read head portion 300 includes the substrate base 32, insulation layer 34, seed layer 35, first magnetic shield 36, G1 insulation layer 38, sensor 40, electrical leads 54, G2 insulation layer 56, second magnetic shield 328, hard baked resist 306, and the electrical insulation layer 59 that is deposited upon the second magnetic shield and photoresist layer surface 332. Thereafter, the write head portion (not shown in FIG. 22) of the third magnetic head embodiment 304 is fabricated. This write head portion may be identical to the write head portion of the prior art magnetic head 30 as described hereabove. However, the magnetic head of the present invention is not to be so limited, and may include virtually any write head design that is compatible with the read head portion 300 described herein.

As with other embodiments of the present invention, a significant feature of the third magnetic head embodiment 304 of the present invention is that the improved material of the second magnetic shield results in reduced sensor signal noise. Also, the improved second magnetic shield may allow for the use of a thinner G2 insulation layer, as described above. This would allow the magnetic shields 36 and 328 to be advantageously fabricated closer together, such that the read gap of the magnetic head 304 is reduced as compared to the prior art.

While the present invention has been shown and described with regard to certain preferred embodiments, it is to be understood that modifications in form and detail will no doubt be developed by those skilled in the art upon reviewing this disclosure. It is therefore intended that the following claims cover all such alterations and modifications that nevertheless include the true spirit and scope of the inventive features of the present invention.

What I claim is:

1. A magnetic head comprising:
a read head portion including:
a first magnetic shield;
a sensor being disposed above said first magnetic shield;
a second magnetic shield structure being disposed above said sensor, said second magnetic shield structure consisting of a magnetic shield element being disposed within an insulative layer, wherein said magnetic shield element is composed of a deposited material.

2. A magnetic head as described in claim 1 wherein said deposited material is CZT.

3. A magnetic head as described in claim 1 wherein said insulative layer is comprised of a hard baked photoresist.

4. A magnetic head as described in claim 1 wherein said insulative layer is comprised of a RIEable material.

5. A magnetic head as described in claim 4 wherein said RIEable material is a material selected from the group consisting of Ta₂O₅, SiO₂, Si₃N₃, and SiOₓN_{y}.

6. A magnetic head comprising:
a read head portion including:
a first magnetic shield;
a first insulation layer being disposed upon said first magnetic shield;
a magnetoresistive sensor being disposed upon said first insulation layer;
a second insulation layer being disposed upon said magnetoresistive sensor;
a second magnetic shield structure being disposed upon said second insulation layer, said second magnetic shield structure including a magnetic shield that is disposed upon said second insulation layer, said second magnetic shield being disposed within an insulative layer, and wherein said second magnetic shield is composed of a deposited material.

7. A magnetic head as described in claim 6 wherein said deposited material is CZT.

8. A magnetic head as described in claim 6 wherein said insulative layer is comprised of a hard baked photoresist.

9. A magnetic head as described in claim 6 wherein said insulative layer is comprised of a RIEable material.

10. A magnetic head as described in claim 9 wherein said RIEable material is a material selected from the group consisting of Ta₂O₅, SiO₂, Si₃N₃, and SiOₓN_{y}.

11. A magnetic head as described in claim 6 wherein said insulative layer is composed of a RIEable material, and wherein said RIEable material differs from a material that comprises said second insulation layer.

12. A magnetic head as described in claim 6 wherein electrical leads are connected to said magnetoresistive sensor, and wherein portions of said second insulation layer are disposed upon said electrical leads, and wherein portions of said insulative layer are disposed upon said electrical leads, and wherein portions of said second insulation layer are disposed upon said insulative layer, such that portions of said insulative layer are disposed between said electrical leads and said second insulation layer.

13. A hard disk drive, comprising:
a motor for rotating a spindle;
a thin film magnetic disk being mounted on said spindle;
an actuator assembly having a magnetic head mounted thereon, wherein said magnetic head includes:
a read head portion including:
a first magnetic shield;
a sensor being disposed above said first magnetic shield;
a second magnetic shield structure being disposed above said sensor, said second magnetic shield structure consisting of a magnetic shield element being disposed within an insulative layer, wherein said magnetic shield element is composed of a deposited material.

14. A hard disk drive as described in claim 13 wherein said deposited material is CZT.

15. A hard disk drive as described in claim 13 wherein said insulative layer is comprised of a hard baked photoresist.

16. A hard disk drive as described in claim 13 wherein said insulative layer is comprised of a RIEable material.

17. A hard disk drive as described in claim 16 wherein said RIEable material is a material selected from the group consisting of Ta₂O₅, SiO₂, Si₃N₃, and SiOₓN_{y}.

18. A hard disk drive, comprising:
a motor for rotating a spindle;
a thin film magnetic disk being mounted on said spindle;
an actuator assembly having a magnetic head mounted thereon, wherein said magnetic head includes:
a read head portion including:
a first magnetic shield;
a first insulation layer being disposed upon said first magnetic shield;
a magnetoresistive sensor being disposed upon said first insulation layer;
a second insulation layer being disposed upon said magnetoresistive sensor;
a second magnetic shield structure being disposed upon said second insulation layer, said second magnetic shield structure including a magnetic shield that is disposed upon said second insulation layer, said second magnetic shield being disposed within an insulative layer, and wherein said second magnetic shield is composed of a deposited material.

19. A hard disk drive as described in claim 18 wherein said deposited material is CZT.

20. A hard disk drive as described in claim 18 wherein said insulative layer is comprised of a hard baked photoresist.

21. A hard disk drive as described in claim 18 wherein said insulative layer is comprised of a RIEable material.

22. A hard disk drive as described in claim 21 wherein said RIEable material is a material selected from the group consisting of Ta₂O₅, SiO₂, Si₃N₃, and SiOₓN_{y}.

23. A hard disk drive as described in claim 18 wherein said insulative layer is composed of a RIEable material, and wherein said RIEable material differs from a material that comprises said second insulation layer.

24. A hard disk drive as described in claim 18 wherein electrical leads are connected to said magnetoresistive sensor, and where said electrical leads are disposed in part upon said first insulation layer, and wherein portions of said second insulation layer are disposed upon said electrical leads, and wherein portions of said insulative layer are disposed upon said electrical leads, and wherein portions of said second insulation layer are disposed upon said insulative layer, such that portions of said insulative layer are disposed between said electrical leads and said second insulation layer.

25. A method for fabricating a magnetic head, comprising:
fabricating a first magnetic shield above a substrate base;
fabricating a magnetoresistive sensor above said first magnetic shield;
depositing an insulative layer above said magnetoresistive sensor, said insulative layer being comprised of a RIEable material;
fabricating a reactive ion etch mask upon said RIEable material;
conducting a reactive ion etch step in which portions of said RIEable material are removed to create a second magnetic shield opening;
depositing a magnetic shield material within said second magnetic shield opening formed within said insulative layer;
performing a CMP step to remove excess portions of said magnetic shield material.

26. A method for fabricating a magnetic head as described in claim 25 wherein said deposited material is CZT.

27. A method for fabricating a magnetic head as described in claim 25 wherein said RIEable material is a material selected from the group consisting of Ta₂O₅, SiO₂, Si₃N₃, and SiOₓN_{y}.

28. A method for fabricating a magnetic head as described in claim 25, including the step of depositing an insulation layer upon said magnetoresistive sensor prior to said step of depositing said insulative layer.

29. A method for fabricating a magnetic head, comprising:
fabricating a first magnetic shield above a substrate base;
fabricating a magnetoresistive sensor above said first magnetic shield;
depositing an insulative layer above said magnetoresistive sensor, said insulative layer being comprised of a photoresist material;
conducting a photolithographic patterning step in which portions of said photoresist material are removed to create a second magnetic shield opening;
baking said photoresist to create a hard baked photoresist;
depositing a magnetic shield material within said second magnetic shield opening formed within said hard baked photoresist layer;
performing a CMP step to remove excess portions of said magnetic shield material.

30. A method for fabricating a magnetic head as described in claim 29 wherein said deposited material is CZT.

31. A method for fabricating a magnetic head as described in claim 29, including the step of depositing an insulation layer upon said magnetoresistive sensor prior to said step of depositing said photoresist layer.

32. A method for fabricating a magnetic head described in claim 29, including the step of depositing an insulation layer within said second magnetic shield opening prior to said step of depositing said magnetic shield material.
